(19) United States
(12) Patent Application Publication
(10) Pub. No.: US 2025/0292285 A1
(43) Pub. Date: Sep. 18, 2025

(54) PREDICTION TOOL FOR SUGGESTING CONTENT FOR USERS

(71) Applicant: Microsoft Technology Licensing, LLC, Redmond, WA (US)

(72) Inventors: Mingzhou ZHOU, Santa Clara, CA (US); Hiroki NAGANUMA, Montreal (CA); Chengming JIANG, Sunnyvale, CA (US)

(73) Assignee: Microsoft Technology Licensing, LLC, Redmond, WA (US)

(21) Appl. No.: 18/602,361

(22) Filed: Mar. 12, 2024

(51) Int. Cl. G06Q 30/0251; G06Q 30/0201

(52) U.S. Cl. CPC G06Q 30/0254; G06Q 30/0201

(57) ABSTRACT

Systems and methods for training a predictive model for suggesting content for users. In particular, a computer device may receive a first set of data, the first set of data indicative of one or more user engagement metrics, generate a predictive model based on the first set of data using a regularized loss algorithm, the regularized loss algorithm including a loss function with a regularization term, the regularization term being a normalized logit loss to adjust the loss function, receive a second set of data, generate an output using the predictive model based on the second set of data, evaluate the output of the predictive model by determining evaluation metrics indicative of predicted performance and reliability of the predictive model, adjust strength of regularization of the regularized loss algorithm based on the evaluation metrics, and train the predictive model using the regularized loss algorithm.

### BACKGROUND

Neural networks have become immensely useful in many fields. While neural networks exhibit high-ranking performance, they often produce overconfident predictions. Overconfident predictions pose a challenge for recommendation systems to accurately predict targeted contents that are relevant to a user and a likelihood that the user will be interested in the targeted contents.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a prediction tool implements a unique training technique that normalizes and calibrates the neural network models during the learning process rather than post-learning to suppress overconfidence and enhance the robustness of neural network models. Specifically, a regularization term is incorporated into a loss algorithm to generate a predictive model for normalizing outputs of the predictive model to improve performance and reliability. In other words, the overconfidence of the predictive model is mitigated by introducing the regularization term in the BCE function during in-training of the predictive model. This negates a need of performing any post-learning adjustments of the predictive model. Additionally, by described further below, the in-training adjustments of the predictive model effectively increased both predicted performance and reliability of the predictive model. It should be appreciated that the term “in-training” of a predictive model refers to a process in which a regularized loss algorithm is fed with labeled examples data (e.g., training, validating, and test data) in order to find appropriate values for weights and biases for the predictive model. This is different from the “post-learning,” which does not affect the training. For example, DNN techniques in CTR estimation often use post-hoc methods for calibration, such as isotonic regression and temperature scaling. While the post-hoc methods may improve calibration without affecting ranking performance, they increase computational complexity and/or do not offer significant enhancements in predicted performance and reliability of the predictive model.

In accordance with at least one example of the present disclosure, a method for training a predictive model for suggesting content for users is provided. The method may include receiving a first set of data, the first set of data indicative of one or more user engagement metrics and generating a predictive model based on the first set of data using a regularized loss algorithm. The regularized loss algorithm includes a loss function with a regularization term, the regularization term being a normalized logit loss to adjust the loss function. The method may further include receiving a second set of data, generating an output using the predictive model based on the second set of data, evaluating the output of the predictive model by determining evaluation metrics indicative of predicted performance and reliability of the predictive model, adjusting strength of regularization of the regularized loss algorithm based on the evaluation metrics, and training the predictive model using the regularized loss algorithm.

In accordance with at least one example of the present disclosure, a computing device for training a predictive model for suggesting content for users is provided. The computing device may include a processor and a memory having a plurality of instructions stored thereon that, when executed by the processor, causes the computing device to receive a first set of data, the first set of data indicative of one or more user engagement metrics and generate a predictive model based on the first set of data using a regularized loss algorithm. The regularized loss algorithm includes a loss function with a regularization term, and the regularization term is a normalized logit loss to adjust the loss function. The computing device may include the plurality of instructions, when executed, further cause the computing device to receive a second set of data, generate an output using the predictive model based on the second set of data, evaluate the output of the predictive model by determining evaluation metrics indicative of predicted performance and reliability of the predictive model, adjust strength of regularization of the regularized loss algorithm based on the evaluation metrics, and train the predictive model using the regularized loss algorithm.

In accordance with at least one example of the present disclosure, a non-transitory computer-readable medium storing instructions for training a predictive model for suggesting content for users is provided. The instructions when executed by one or more processors of a computing device, cause the computing device to receive a first set of data, the first set of data indicative of one or more user engagement metrics and train a predictive model based on the first set of data using a regularized loss algorithm. The regularized loss algorithm includes a loss function with a regularization term. In accordance with at least one aspect of the above non-transitory computer-readable medium, the instructions when executed by the one or more processors may further cause the computing device to receive a second set of data, generate an output using the predictive model based on the second set of data, evaluate the output of the predictive model by determining evaluation metrics indicative of predicted performance and reliability of the predictive model, adjust strength of regularization of the regularized loss algorithm based on the evaluation metrics, and retrain the predictive model using the regularized loss algorithm.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of an operating environment in which a prediction tool may be implemented in accordance with examples of the present disclosure;

FIG. 2 depicts a flowchart of an example method of evaluating a content cost associated with a targeted content in accordance with examples of the present disclosure;

FIG. 3 depicts a flowchart of an example method of training a predictive model using a regularized loss algorithm in accordance with examples of the present disclosure;

FIG. 4 is a block diagram illustrating example physical components of a computing device with which aspects of the disclosure may be practiced;

FIG. 5 is a simplified block diagram of a computing device with which aspects of the present disclosure may be practiced; and

FIG. 6 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Neural networks have become immensely useful in many fields. While neural networks exhibit high-ranking performance, they often produce overconfident predictions. Overconfident predictions pose a challenge for recommendation systems to accurately predict targeted contents that are relevant to a user and a likelihood that the user will be interested in the targeted contents.

In accordance with examples of the present disclosure, to suppress overconfidence and enhance the robustness of neural network models, a prediction tool implements a unique training technique that normalizes and calibrates the neural network models during the learning process rather than post-learning. Specifically, a regularization term is incorporated into a loss algorithm to generate a predictive model for normalizing outputs of the predictive model to improve performance and reliability. For example, deep neural networks (DNNs) tend to make extreme confidence in predictions due to the nature of binary training data labels. The prediction tool implements the unique training technique to regularize the model's output and prevent the DNN from memorizing the training data and making overconfident predictions.

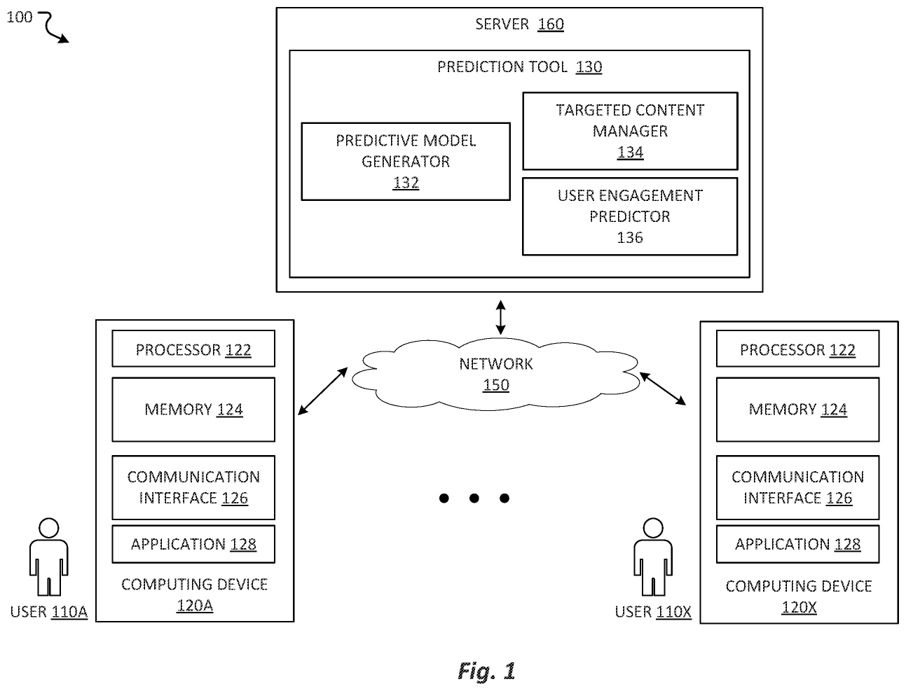

FIG. 1 depicts a block diagram of an example of an operating environment 100 in which a prediction tool may be implemented in accordance with examples of the present disclosure. To do so, the operating environment 100 includes a computing device 120 associated with the user 110. The operating environment 100 may further include one or more remote devices, such as a server 160, that are communicatively coupled to the computing device 120 via a network 150. The network 150 may include any kind of computing network including, without limitation, a wired or wireless local area network (LAN), a wired or wireless wide area network (WAN), and/or the Internet.

The computing device 120 includes an application 128 executing on a computing device 120 having a processor 122, a memory 124, and a communication interface 126. The application 128 may be a app or a web browser that allows the user 110 to access content items on a advertising platform. The content items may include a targeted content (e.g., advertisements), photos, videos, feeds, updates, messages, or any other types of content shared among users. The application 128 allows the users to engage with one or more content items on the website or the advertising platform. Additionally, the computing device 120 may be, but is not limited to, a computer, a notebook, a laptop, a mobile device, a smartphone, a tablet, a portable device, a wearable device, or any other suitable computing device that is capable of accessing the website or advertising platform.

The server 160 includes a prediction tool 130, which is configured to predict a likelihood that users 100 will be interested in targeted contents. To do so, the prediction tool 130 further includes a predictive model generator 132, a targeted content manager 134, and a user engagement predictor 136.

The predictive model generator 132 is configured to generate and train a predictive model that is adapted to predict a probability that users 100 will engage with a targeted content. The predictive model is generated and trained using a regularized loss algorithm. The regularized loss algorithm includes a loss function and a regularization term that is adjusted based on one or more evaluation metrics indicative of predicted performance and reliability of the predictive model to minimize losses between a predicted value and an actual value. For example, the loss function may be a binary cross entropy (BCE) function. BCE, also known as binary log loss or binary cross-entropy loss, is a loss function used in machine learning and deep learning for tasks like binary classification (e.g., categorize data into two classes). It is designed to measure the difference between predicted binary outcomes and actual binary labels, quantify the dissimilarity between probability distributions, and train predictive models by penalizing inaccurate predictions. However, BCE's penalty on predictive models for any uncertainty within their predictions, thereby compelling them to generate probabilities hovering near extreme ends (e.g., close either to 0 or 1), induces overconfidence in predictive models' predictions, compromising the reliability of their probability estimates. To address the overconfidence issue, the regularization term, which is a normalized logit loss function, is introduced in the BCE function in order to normalize logits used for the BCE. By normalizing the norm of the logit, it prevents the norm from increasing, thereby suppressing overconfidence. In other words, the overconfidence of a predictive model is mitigated by introducing the regularization term in the BCE function during in-training of the predictive model. This negates a need of performing any post-learning adjustments or calibrations of the predictive model in an effort to mitigate overconfidence. Additionally, by described further below, the in-training adjustments of the predictive model effectively increased both predicted performance and reliability of the predictive model. It should be appreciated that the term “in-training” of a predictive model refers to a process in which a regularized loss algorithm is fed with labeled examples data (e.g., training, validating, and test data) in order to find appropriate values for weights and biases for the predictive model. This is different from the “post-learning,” which does not affect the training. For example, DNN techniques in CTR estimation often use post-hoc methods for calibration, such as isotonic regression and temperature scaling. While the post-hoc methods may improve calibration without affecting ranking performance, they increase computational complexity and/or do not offer significant enhancements in predicted performance and reliability of the predictive model.

The predictive model generator 132 is further configured to evaluate outputs of the predictive model by determining evaluation metrics indicative of predicted performance and reliability of the predictive model. For example, the evaluation metrics include an area under the curve (AUC) indicative of predicted performance and an expected calibration error (ECE) indicative of predicted reliability. In other words, the user engagement predictor 136 is configured to train the predictive model with the regularized loss algorithm to increase the AUC and decrease the ECE to suppress overconfidence and/or underconfidence.

The targeted content manager 134 is configured to manage targeted contents that are advertised on a website or an advertising platform and generate clickthrough rate (CTR) metric associated with the targeted contents. For example, the targeted content manager 134 is configured to determine whether a content cost for a targeted content is appropriate for a predicted user engagement with the targeted content. To do so, the targeted content manager 134 is configured to receive an indication or identity of a targeted content (e.g., advertisement) to be analyzed and one or more user engagement metrics associated with the users 110 on the website or advertising platform. For example, the user engagement metrics include click-through rate (CTR) data associated with users of a social media platform during a predetermined time period (e.g., last 90 days). In the illustrative embodiment, the user engagement metrics are stored in a user engagement database, which may be stored on the server 160 or a remote device communicatively coupled to the server 160.

The user engagement predictor 136 is configured to predict a likelihood that the users 100 will engage with the targeted contents using a predictive model that is generated by a predictive model generator 132. In the illustrative embodiment, the output is a predicted probability that the users will click on the targeted content (e.g., click rate) and a reliability score of the prediction. In other words, the targeted content manager 134 is configured to determine a likelihood of the targeted content being selected by the users 110 based on the output.

Based on the output, the targeted content manager 134 is further configured to determine whether the content cost for the targeted content is appropriate, acceptable, or otherwise reasonable. The content cost is a cost that a content provider of the targeted content is for promoting the targeted content on the advertising platform. For example, a content cost for the targeted content is initially or previously determined based on an expected click rate at which the users of the advertising platform will select the targeted content. In other words, the higher the expected click rate of the targeted content being selected by the users, the higher the content cost for the targeted content. As such, the targeted content manager 134 is configured to determine whether a difference between the expected click rate based on the content cost and the predicted click rate based on the output is within an acceptable range (e.g., +5%). If the difference is within the acceptable range, the targeted content manager 134 is configured to indicate that the content cost set for the targeted content is reasonable and appropriate. If, however, the difference is outside of the acceptable range, the targeted content manager 134 is configured to indicate that the content cost for the targeted content does not accurately represent the likelihood that the targeted content will be selected by the users and needs to be adjusted. In some embodiments, the targeted content manager 134 is further configured to provide a new content cost that accurately reflects the likelihood of the targeted content being selected by the users 110.

Depending on resources, capabilities, and capacity of the server 160, It should be appreciated that the training of the predictive model may be performed by another remote computing device that is communicatively coupled to the server 160.

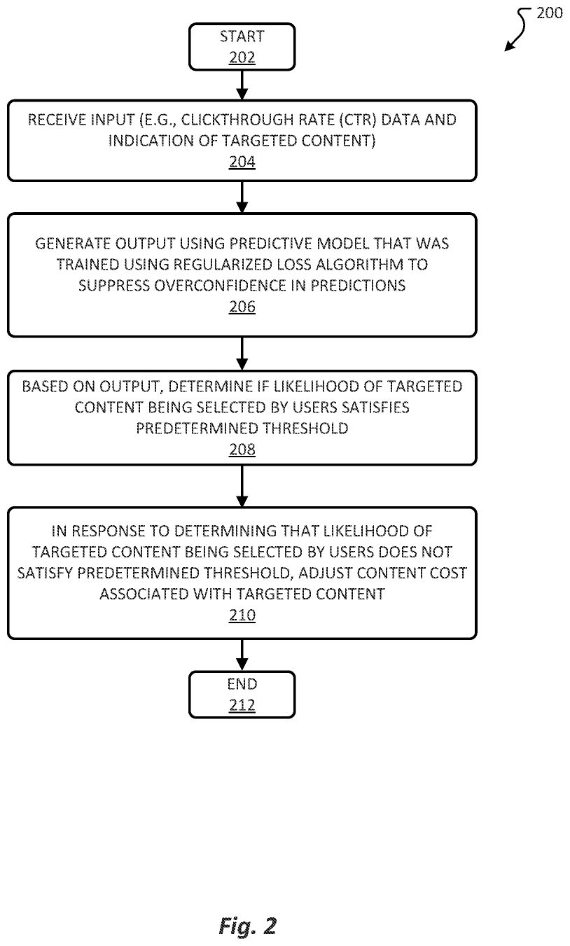

Referring now to FIG. 2, a method 200 for evaluating a content cost associated with a targeted content on a website or advertising platform in accordance with examples of the present disclosure is provided. A general order for the steps of the method 200 is shown in FIG. 2. Generally, the method 200 starts at 202 and ends at 212. The method 200 may include more or fewer steps or may arrange the order of the steps differently than those shown in FIG. 2. In the illustrative aspect, the method 200 is performed by a server (e.g., a server 160). However, it should be appreciated that one or more steps of the method 200 may be performed by another remote device communicatively coupled to the server 160.

Specifically, in some aspects, the method 200 may be performed by a prediction tool (e.g., 130). For example, the computing device 120 may be, but is not limited to, a computer, a notebook, a laptop, a mobile device, a smartphone, a tablet, a portable device, a wearable device, or any other suitable computing device that is capable of executing a prediction tool (e.g., 130). For example, the server 160 may be any suitable computing device that is capable of communicating with the computing device 120. The method 200 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), or other hardware device. Hereinafter, the method 200 shall be explained with reference to the systems, components, modules, software, data structures, user interfaces, etc. described in conjunction with FIG. 1 and FIGS. 4-7.

The method 200 starts at operation 202, where flow may proceed to 204. At operation 204, the prediction tool 130 receives an input. The input includes one or more user engagement metrics associated with user on a website or advertising platform and an indication or identity of a targeted content (e.g., advertisement) on the website or advertising platform. For example, the user engagement metrics include click-through rate (CTR) data associated with users of a website or advertising platform during a predetermined time period (e.g., last 90 days). It should be appreciated that, in some embodiments, the targeted content is one or more multi-modal contents.

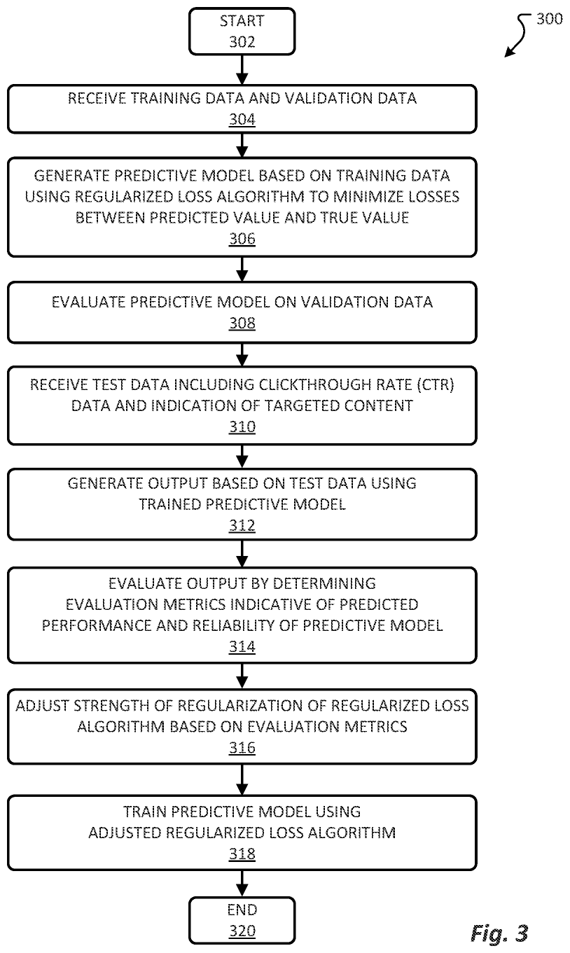

At operation 206, the prediction tool 130 generates an output using a predictive model. As described further below in FIG. 3, the predictive model is trained using a regularized loss algorithm. The regularized loss algorithm includes a regularization term that is adjusted based on one or more evaluation metrics indicative of predicted performance and reliability of the predictive model to minimize losses between a predicted value and a true value. In other words, an output of the predictive model is normalized during training to mitigate overconfidence in predictions. For example, in the illustrative embodiment, the output is a predicted probability that the users will click on the targeted content (e.g., click rate) and a reliability score of the prediction. In other words, the prediction tool 130 determines a likelihood of the targeted content being selected by the users of the website or advertising platform based on the output.

At operation 208, the prediction tool 130 determines if the likelihood of the targeted content being selected by the users (e.g., a predicted click rate) satisfies a predetermined threshold. In the illustrative embodiment, the predetermined threshold is individually tailored to the targeted content.

For example, the predetermined threshold is based on a content cost associated with the targeted content. The content cost is a cost that a content provider of the targeted content is for promoting the targeted content on the website or advertising platform. For example, a content cost for the targeted content is determined based on an expected click rate at which the users of the website or advertising platform will select the targeted content. In other words, the higher the expected click rate of the targeted content being selected by the users, the higher the content cost for the targeted content. As such, in this example, the predetermined threshold is the expected click rate that the users will select the targeted content. The prediction tool 130 compares the expected click rate based on the content cost and the predicted click rate based on the output and determines whether the difference between the two click rates is within an acceptable range (e.g., ±5%).

If the likelihood of the targeted content being selected by the users satisfies the predetermined threshold, the prediction tool 130 determines that the content cost set for the targeted content is reasonable and appropriate. For example, the likelihood of the targeted content being selected by the users satisfies the predetermined threshold if the difference between the expected click rate based on the content cost and the predicted click rate based on the output is within the acceptable range.

If, however, the likelihood of the targeted content being selected by the users does not satisfy the predetermined threshold, the prediction tool 130 determines that the content cost set for the targeted content is not reasonable and needs to be adjusted. Referring to the example above, the likelihood of the targeted content being selected by the users does not satisfy the predetermined threshold if the difference between the expected click rate based on the content cost and the predicted click rate based on the output is outside of the acceptable range. In other words, the content cost for the targeted content does not accurately represent the likelihood that the targeted content will be selected by the users.

At operation 212, in response to determining that the likelihood does not satisfy the predetermined threshold, the prediction tool 130 adjusts a content cost associated with the targeted content. For example, if the expected click rate is higher than the predicted click rate, the prediction tool 130 provides an indication that the content cost should be lowered. If the predicted click rate is higher than the expected click rate, the prediction tool 130 provides an indication that the content cost should be higher. According to some embodiments, the prediction tool 130 may further provide a new content cost that accurately reflects the likelihood of the targeted content being selected by the users.

Referring now to FIG. 3, a method 300 for transforming copied content item in accordance with examples of the present disclosure is provided. A general order for the steps of the method 300 is shown in FIG. 3. Generally, the method 300 starts at 302 and ends at 320. The method 300 may include more or fewer steps or may arrange the order of the steps differently than those shown in FIG. 3. In the illustrative aspect, the method 300 is performed by a server (e.g., a server 160). However, it should be appreciated that one or more steps of the method 300 may be performed by another remote device communicatively coupled to the server 160.

Specifically, in some aspects, the method 300 may be performed by a prediction tool (e.g., 130). For example, the computing device 120 may be, but is not limited to, a computer, a notebook, a laptop, a mobile device, a smartphone, a tablet, a portable device, a wearable device, or any other suitable computing device that is capable of executing a prediction tool (e.g., 130). For example, the server 160 may be any suitable computing device that is capable of communicating with the computing device 120. The method 300 can be executed as a set of computer-executable instructions executed by a computer system and encoded or stored on a computer readable medium. Further, the method 300 can be performed by gates or circuits associated with a processor, Application Specific Integrated Circuit (ASIC), a field programmable gate array (FPGA), a system on chip (SOC), or other hardware device. Hereinafter, the method 300 shall be explained with reference to the systems, components, modules, software, data structures, user interfaces, etc. described in conjunction with FIG. 1 and FIGS. 4-7.

The method 300 starts at operation 302, where flow may proceed to 304. At operation 304, training data and validation data are received. For example, the training data include examples or samples that are used to teach or train a predictive model. The predictive model uses the training data to understand the patterns and relationships within the data, thereby learning to make predictions or decisions without being explicitly programmed to perform a specific task. The validation data is used to estimate the accuracy of the predictive model. The validation data generally includes unbiased inputs and expected results designed to check the function and performance of the predictive model. For example, the training and validation data include includes clickthrough rate (CTR) data and indications or identities of one or more targeted contents. In some embodiments, the training and validation data include clickthrough rate (CTR) data associated with a platform collected during a predetermined time period (e.g., 14 days of data collected 5 days ago).

At operation 306, a predictive model is generated based on the training data using a regularized loss algorithm. The regularized loss algorithm includes a loss function and a regularization term to suppress overconfidence and/or underconfidence in predictions by minimizing losses between a predicted value and a true value. In the illustrative embodiment, the predictive model is a deep neural network (DNN) model. However, it should be appreciated that the predictive model may be any type of machine learning model capable of predicting future behavior.

For example, the loss function may be a binary cross entropy (BCE) function. BCE, also known as binary log loss or binary cross-entropy loss, is a loss function used in machine learning and deep learning for tasks like binary classification (e.g., categorize data into two classes). It is designed to measure the difference between predicted binary outcomes and actual binary labels, quantify the dissimilarity between probability distributions, and train predictive models by penalizing inaccurate predictions. However, BCE's penalty on predictive models for any uncertainty within their predictions, thereby compelling them to generate probabilities hovering near extreme ends (e.g., close either to 0 or 1), induces overconfidence in predictive models' predictions, compromising the reliability of their probability estimates. To address the overconfidence issue, the regularization term is introduced in the BCE function in order to normalize logits used for the BCE. By normalizing the norm of the logit, it prevents the norm from increasing, thereby suppressing overconfidence. In other words, the overconfidence of a predictive model is mitigated by introducing the regularization term in the BCE function during in-training of the predictive model. This negates a need of performing any post-learning adjustments of the predictive model. Additionally, by described further below, the in-training adjustments of the predictive model effectively increased both predicted performance and reliability of the predictive model. It should be appreciated that the term “in-training” of a predictive model refers to a process in which a regularized loss algorithm is fed with labeled examples data (e.g., training, validating, and test data) in order to find appropriate values for weights and biases for the predictive model. This is different from the “post-learning,” which does not affect the training. For example, DNN techniques in CTR estimation often use post-hoc methods for calibration, such as isotonic regression and temperature scaling. While the post-hoc methods may improve calibration without affecting ranking performance, they increase computational complexity and/or do not offer significant enhancements in predicted performance and reliability of the predictive model.

An exemplary regularized loss algorithm is shown below.
LBCE+LN-Regularization (f(x; θ), y, μ, τ)=μLBCE(f(x; θ), y)+(1−μ)LBCELN(f(x; θ), y, τ), wherein the exemplary regularized loss algorithm implemented a regularization term in a baseline. In this example, the regularization term is a normalized logit loss function and is incorporated into the baseline loss function.

$$Baseline \text{:} LB CE ( f ( x ; θ ) , y ) = - y log σ ( f ) - ( 1 - y ) log ( 1 - σ ( f ) )$$

$$Regularization term \text{:} LBCELN ( f ( x ; θ ) , y , τ ) = - y log σ ( \frac{f}{τ ‖ f ‖} ) - ( 1 - y ) log ( 1 - σ ( \frac{f}{σ ‖ f ‖} ) )$$

At operation 308, the predictive model is evaluated on the validation data.

At operation 310, once the model is generated, test data is received. The test data is used to verify the predictive model's functionality. For example, the test data provides a simulated real-world check using unseen inputs and expected results. For example, the test data includes clickthrough rate (CTR) data and indications or identities of one or more targeted contents. In some embodiments, the test data includes CTR data associated with a page (e.g., a webpage, a platform) collected during a predetermined time period (e.g., 1 day). It should be appreciated that the labeled examples data (e.g., training, validating, and test data) may be generated by a recommender system associated with a page that hosts one or more targeted contents.

At operation 312, an output is generated using the predictive model. For example, based on an indication or identity of a targeted content, the predictive model generates an output indicative of a probability that people who view the targeted content will click on the targeted content.

At operation 314, the output is evaluated by determining evaluation metrics indicative of predicted performance and reliability of the predictive model. For example, the evaluation metrics include an area under the curve (AUC) indicative of predicted performance and an expected calibration error (ECE) indicative of predicted reliability. In other words, the predictive model that is trained with the regularized loss algorithm to increase the AUC and decrease the ECE to suppress overconfidence and/or underconfidence.

At operation 316, strength of the regularization of the regularized loss algorithm (e.g., weights of the regularized loss algorithm) is adjusted based on the evaluation metrics. For example, in the exemplary regularized loss algorithm shown above, the regularization term is (1−μ)LBCELN(f(x; θ), y, τ), and the strength of the regularization of the regularized loss algorithm is adjusted by changing the μ value.

At operation 318, the predictive model is trained using the regularized loss algorithm. In other words, an output of the predictive model is normalized during training to mitigate overconfidence in predictions.

As shown in Table 1, same data set was used to test a predictive model that is trained using the baseline algorithm and a predictive model is trained using the regularized loss algorithm. As described above, the baseline algorithm is a binary cross entropy (BCE) loss function and the regularized loss algorithm a BCE loss function with a regularization term. More specifically, the regularization term is a normalized logit loss function and is incorporated into the baseline loss function. The regularization term is adapted to normalize the norm of the logit used for the BCE. As can be seen in Table 1, a model trained using a normalized logit loss function alone shows an improvement in ECE but only a marginal improvement in AUC. This may be due to overly strong regularization effect that may hinder part of the learning process. In order to take advance of the improvement in ECE, the normalized logit loss function is incorporated into the BCE loss function as a regularization term. As a result, a predictive model trained using the regularized loss algorithm achieved improvements in both AUC and ECE, thereby taking advantage of characteristics of each type of loss and addressing the overconfidence issue during the training of the predictive model. Additionally, this approach is an improvement over an existing method of adjusting overconfidence post-learning of a predictive model (e.g., after the training process of a predictive model is complete). Not only the existing method increases computational complexity, it can only improve ECE and not AUC.

As can be seen in Table 1, the predictive model is trained using the regularized loss algorithm outperformed the predictive model is trained using the baseline algorithm in both AUC and ECE, indicating effectiveness in addressing overconfidence/underconfidence. Specifically, the increase in the area under the curve (AUC) indicates increase in the predicted performance, and the decrease in expected calibration error (ECE) indicates increase in reliability of predictions.

TABLE 1
Empirical results comparing a predictive model trained
using the baseline model and a predictive model
trained using the regularized loss algorithm.

| | AUC | ECE |
|---|---|---|
| Baseline | 93.42 | 53.43 |
| Normalized logit loss function | 93.57 (↑ 0.15) | 36.66 (↓ 16.77) |
| Regularized loss algorithm | 95.60 (↑ 2.18) | 51.38 (↓ 2.05) |

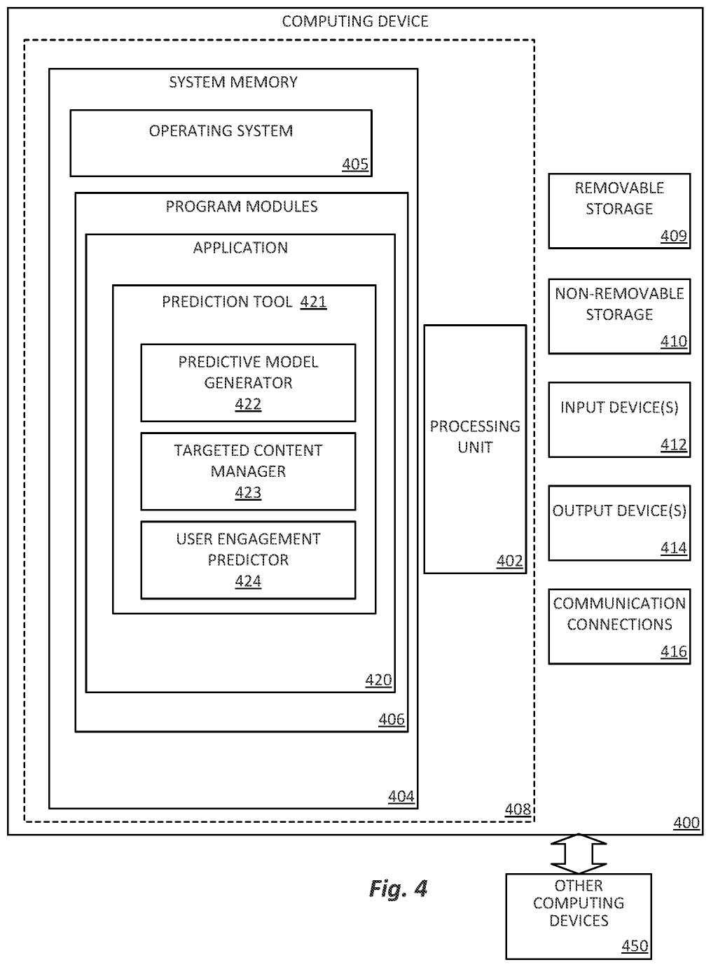

FIGS. 4-6 and the associated descriptions provide a discussion of a variety of operating environments in which aspects of the disclosure may be practiced. However, the devices and systems illustrated and discussed with respect to FIGS. 4-6 are for purposes of example and illustration and are not limiting of a vast number of computing device configurations that may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices described above, including one or more devices associated with machine learning service (e.g., server 160), as well as computing device 140 discussed above with respect to FIG. 1. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories.

The system memory 404 may include an operating system 405 and one or more program modules 406 suitable for running software application 420, such as one or more components supported by the systems described herein. As examples, system memory 404 may store a prediction tool 421, which further includes a predictive model generator 422, a targeted content manager 423, and a user management predictor 424. The operating system 405, for example, may be suitable for controlling the operation of the computing device 400.

Furthermore, aspects of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 (e.g., application 420) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 450. Examples of suitable communication connections 416 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

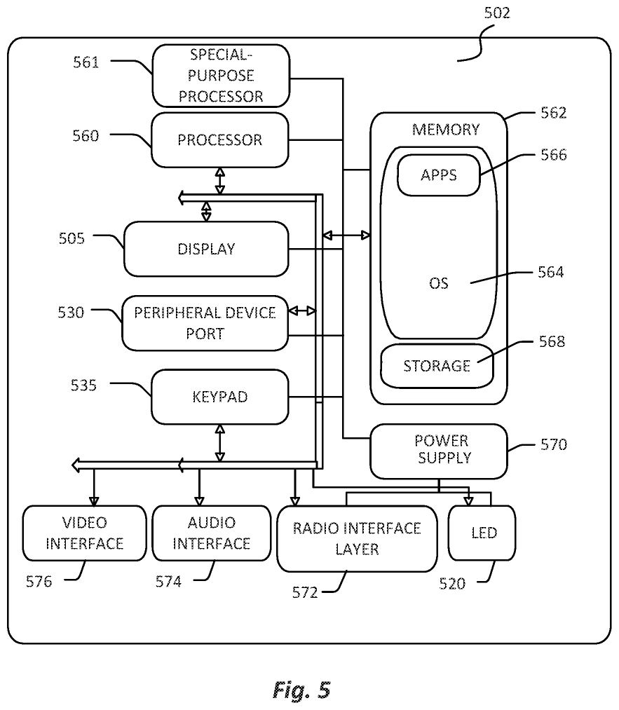

FIG. 5 illustrates a system 500 that may, for example, be a mobile computing device, such as a mobile telephone, a smart phone, wearable computer (such as a smart watch), a tablet computer, a laptop computer, and the like, with which aspects of the disclosure may be practiced. In one example, the system 500 is implemented as a “smart phone” capable of running one or more applications (e.g., browser, e-mail, calendaring, contact managers, messaging clients, games, and media clients/players). In some aspects, the system 500 is integrated as a computing device, such as an integrated personal digital assistant (PDA) and wireless phone.

In a basic configuration, such a mobile computing device is a handheld computer having both input elements and output elements. The system 500 typically includes a display 505 and one or more input buttons that allow the user to enter information into the system 500. The display 505 may also function as an input device (e.g., a touch screen display).

If included, an optional side input element allows further user input. For example, the side input element may be a rotary switch, a button, or any other type of manual input element. In alternative aspects, system 500 may incorporate more or less input elements. For example, the display 505 may not be a touch screen in some aspects. In another example, an optional keypad 535 may also be included, which may be a physical keypad or a “soft” keypad generated on the touch screen display.

In various aspects, the output elements include the display 505 for showing a graphical user interface (GUI), a visual indicator (e.g., a light emitting diode 520), and/or an audio transducer 525 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 500 also includes a non-volatile storage area 568 within the memory 562. The non-volatile storage area 568 may be used to store persistent information that should not be lost if the system 500 is powered down. The application programs 566 may use and store information in the non-volatile storage area 568, such as e-mail or other messages used by an e-mail application, and the like. A synchronization application (not shown) also resides on the system 500 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the system 500 described herein (e.g., a content capture manager, a content retrieval manager, etc.).

The system 500 has a power supply 570, which may be implemented as one or more batteries. The power supply 570 might further include an external power source, such as an AC adapter or a powered docking cradle that supplements or recharges the batteries.

The system 500 may also include a radio interface layer 572 that performs the function of transmitting and receiving radio frequency communications. The radio interface layer 572 facilitates wireless connectivity between the system 500 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 may be used to provide visual notifications, and/or an audio interface 574 may be used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with aspects of the present disclosure, the microphone may also serve as an audio sensor to facilitate control of notifications, as will be described below. The system 500 may further include a video interface 576 that enables an operation of an on-board camera 530 to record still images, video stream, and the like.

It will be appreciated that system 500 may have additional features or functionality. For example, system 500 may also include additional data storage devices (removable and/or non-removable) such as, magnetic disks, optical disks, or tape. Such additional storage is illustrated in FIG. 5 by the non-volatile storage area 568.

Data/information generated or captured and stored via the system 500 may be stored locally, as described above, or the data may be stored on any number of storage media that may be accessed by the device via the radio interface layer 572 or via a wired connection between the system 500 and a separate computing device associated with the system 500, for example, a server computer in a distributed computing network, such as the Internet. As should be appreciated, such data/information may be accessed via the radio interface layer 572 or via a distributed computing network. Similarly, such data/information may be readily transferred between computing devices for storage and use according to any of a variety of data/information transfer and storage means, including electronic mail and collaborative data/information sharing systems.

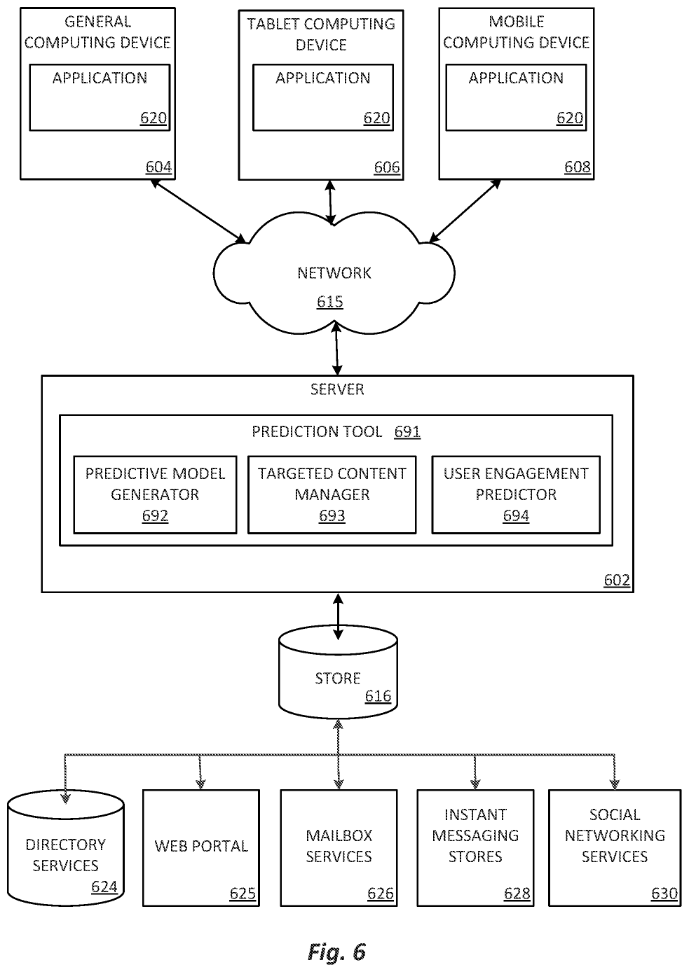

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using a directory service 624, a web portal 625, a mailbox service 626, an instant messaging store 628, or a social networking site 630.

An application 620 (e.g., similar to the application 420) may be employed by a client that communicates with server device 602. Additionally, or alternatively, a prediction tool 691, which further includes a predictive model generator 692, a targeted content manager 693, and a user engagement predictor 694, may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these examples of the computing devices may obtain content from the store 616, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for training a predictive model for suggesting content for users is provided. The method may include receiving a first set of data, the first set of data indicative of one or more user engagement metrics and generating a predictive model based on the first set of data using a regularized loss algorithm. The regularized loss algorithm includes a loss function with a regularization term, the regularization term being a normalized logit loss to adjust the loss function. The method may further include receiving a second set of data, generating an output using the predictive model based on the second set of data, evaluating the output of the predictive model by determining evaluation metrics indicative of predicted performance and reliability of the predictive model, adjusting strength of regularization of the regularized loss algorithm based on the evaluation metrics, and training the predictive model using the regularized loss algorithm.

In accordance with at least one aspect of the above method, the method may include where the evaluation metrics may include an area under the curve (AUC) indicative of predicted performance and an expected calibration error (ECE) indicative of predicted reliability.

In accordance with at least one aspect of the above method, the method may include where adjusting the strength of regularization of the regularized loss algorithm based on the evaluation metrics comprises adjusting one or more parameters of the regularized loss algorithm to adjust the regularization term based on the evaluation metrics.

In accordance with at least one aspect of the above method, the method may include where the one or more user engagement metrics include clickthrough rate (CTR).

In accordance with at least one aspect of the above method, the method may include where the second set of data includes clickthrough rate (CTR) data of a user, and the output indicates a likelihood that the user will be interest in the one or more targeted contents.

In accordance with at least one aspect of the above method, the method may include where the regulation term is configured to suppress overconfidence and underconfidence.

In accordance with at least one aspect of the above method, the method may include where the loss function is a binary cross entropy (BCE) function, and the regularization term is adapted to normalize logits used for the BCE.

In accordance with at least one aspect of the above method, the method may include where the predictive model is a deep neural network model.

In accordance with at least one aspect of the above method, the method may include where the predictive model is configured to normalize outputs during training of the predictive model using the regularized loss algorithm to mitigate overconfidence in the outputs of the predictive model.

In accordance with at least one aspect of the above method, the method may further include receiving a third set of data, the third set of data including one or more user engagement metrics, based on the third set of data using the trained predictive model, determining a likelihood of a targeted content being selected by users, and upon determining the likelihood of user selection, presenting a prediction value of the targeted content.

In accordance with at least one example of the present disclosure, a computing device for training a predictive model for suggesting content for users is provided. The computing device may include a processor and a memory having a plurality of instructions stored thereon that, when executed by the processor, causes the computing device to receive a first set of data, the first set of data indicative of one or more user engagement metrics and generate a predictive model based on the first set of data using a regularized loss algorithm. The regularized loss algorithm includes a loss function with a regularization term, and the regularization term is a normalized logit loss to adjust the loss function. The computing device may include the plurality of instructions, when executed, further cause the computing device to receive a second set of data, generate an output using the predictive model based on the second set of data, evaluate the output of the predictive model by determining evaluation metrics indicative of predicted performance and reliability of the predictive model, adjust strength of regularization of the regularized loss algorithm based on the evaluation metrics, and train the predictive model using the regularized loss algorithm.

In accordance with at least one aspect of the above computing device, the computing device may include where the evaluation metrics include an area under the curve (AUC) indicative of predicted performance and an expected calibration error (ECE) indicative of predicted reliability, and the one or more user engagement metrics include clickthrough rate (CTR).

In accordance with at least one aspect of the above computing device, the computing device may include where adjusting the strength of regularization of the regularized loss algorithm based on the evaluation metrics comprises adjusting one or more parameters of the regularized loss algorithm to adjust the regularization term based on the evaluation metrics.

In accordance with at least one aspect of the above computing device, the computing device may include where the second set of data includes clickthrough rate (CTR) data of a user, and the output indicates a likelihood that the user will be interest in the one or more targeted contents.

In accordance with at least one aspect of the above computing device, the computing device may include where the loss function is a binary cross entropy (BCE) function, and the regularization term is adapted to normalize logits used for the BCE, and the predictive model is a deep neural network model.

In accordance with at least one aspect of the above computing device, the computing device may include where the predictive model is configured to normalize outputs during training of the predictive model using the regularized loss algorithm to mitigate overconfidence in the outputs of the predictive model.

In accordance with at least one aspect of the above computing device, the computing device may include the plurality of instructions, when executed, further cause the computing device to receive a third set of data, the third set of data including one or more user engagement metrics, based on the third set of data using the trained predictive model, determine a likelihood of a targeted content being selected by users, and upon determination of the likelihood of user selection, present a prediction value of the targeted content.

In accordance with at least one example of the present disclosure, a non-transitory computer-readable medium storing instructions for training a predictive model for suggesting content for users is provided. The instructions when executed by one or more processors of a computing device, cause the computing device to receive a first set of data, the first set of data indicative of one or more user engagement metrics and train a predictive model based on the first set of data using a regularized loss algorithm. The regularized loss algorithm includes a loss function with a regularization term. In accordance with at least one aspect of the above non-transitory computer-readable medium, the instructions when executed by the one or more processors may further cause the computing device to receive a second set of data, generate an output using the predictive model based on the second set of data, evaluate the output of the predictive model by determining evaluation metrics indicative of predicted performance and reliability of the predictive model, adjust strength of regularization of the regularized loss algorithm based on the evaluation metrics, and retrain the predictive model using the regularized loss algorithm.

In accordance with at least one aspect of the above non-transitory computer-readable medium, the instructions when executed by one or more processors of a computing device may include where adjusting the strength of regularization of the regularized loss algorithm based on the evaluation metrics comprises adjusting one or more parameters of the regularized loss algorithm to adjust the regularization term based on the evaluation metrics.

In accordance with at least one aspect of the above non-transitory computer-readable medium, the instructions when executed by the one or more processors may further cause the computing device to receive a third set of data, the third set of data including one or more user engagement metrics, based on the third set of data using the trained predictive model, determine a likelihood of a targeted content being selected by users, and upon determination of the likelihood of user selection, present a prediction value of the targeted content.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

1. A method for training a predictive model for suggesting content for users, the method comprising:
receiving a first set of data, the first set of data indicative of one or more user engagement metrics;
generating a predictive model based on the first set of data using a regularized loss algorithm, the regularized loss algorithm including a loss function with a regularization term, the regularization term being a normalized logit loss to adjust the loss function, wherein the loss function is a binary cross entropy (BCE) function, and the regularization term is adapted to normalize logits used for the BCE;
receiving a second set of data;
generating an output using the predictive model based on the second set of data;
evaluating the output of the predictive model by determining evaluation metrics indicative of predicted performance and reliability of the predictive model;
adjusting strength of regularization of the regularized loss algorithm based on the evaluation metrics; and
training the predictive model using the regularized loss algorithm, wherein the trained predictive model is used to generate a probability score representing an interaction with a content item and a reliability score representing a confidence level associated with the probability score.

2. The method of claim 1, wherein the evaluation metrics include an area under the curve (AUC) indicative of predicted performance and an expected calibration error (ECE) indicative of predicted reliability.

3. The method of claim 1, wherein adjusting the strength of regularization of the regularized loss algorithm based on the evaluation metrics comprises adjusting one or more parameters of the regularized loss algorithm to adjust the regularization term based on the evaluation metrics.

4. The method of claim 1, wherein the one or more user engagement metrics include clickthrough rate (CTR).

5. The method of claim 1, wherein the second set of data includes clickthrough rate (CTR) data of a user, and the output indicates a likelihood that the user will be interested in the one or more targeted contents.

6. The method of claim 1, comprising:
receiving a request for content to display to an electronic device;
generating, using the trained predictive model, the probability of an interaction with a content item of a set of content items; and
selecting the content item for display on the electronic device based on the generated probability for the selected content item.

7. (canceled)

8. The method of claim 1, wherein the predictive model is a deep neural network model.

9. (canceled)

10. The method of claim 1, further comprising:
receiving a third set of data, the third set of data including one or more user engagement metrics;
based on the third set of data using the trained predictive model, determining a likelihood of a targeted content being selected by users; and
upon determining the likelihood of user selection, presenting a prediction value of the targeted content.

11. A computing device for training a predictive model for suggesting content for users, the computing device comprising:
a processor; and
a memory having a plurality of instructions stored thereon that, when executed by the processor, causes the computing device to:
receive a first set of data, the first set of data indicative of one or more user engagement metrics;
generate a predictive model based on the first set of data using a regularized loss algorithm, the regularized loss algorithm including a loss function with a regularization term, the regularization term being a normalized logit loss to adjust the loss function, wherein the loss function is a binary cross entropy (BCE) function, and the regularization term is adapted to normalize logits used for the BCE;
receive a second set of data;
generate an output using the predictive model based on the second set of data;
evaluate the output of the predictive model by determining evaluation metrics indicative of predicted performance and reliability of the predictive model;
adjust strength of regularization of the regularized loss algorithm based on the evaluation metrics; and
train the predictive model using the regularized loss algorithm, wherein the trained predictive model is used to generate a probability score representing an interaction with a content item and a reliability score representing a confidence level associated with the probability score.

12. The computing device of claim 11, wherein the evaluation metrics include an area under the curve (AUC) indicative of predicted performance and an expected calibration error (ECE) indicative of predicted reliability, and the one or more user engagement metrics include clickthrough rate (CTR).

13. The computing device of claim 11, wherein adjusting the strength of regularization of the regularized loss algorithm based on the evaluation metrics comprises adjusting one or more parameters of the regularized loss algorithm to adjust the regularization term based on the evaluation metrics.

14. The computing device of claim 11, wherein the second set of data includes clickthrough rate (CTR) data of a user, and the output indicates a likelihood that the user will be interest in the one or more targeted contents.

15. The computing device of claim 11, wherein the computing device is further caused to:
receive a request for content to display to an electronic device;
generate, using the trained predictive model, the probability of an interaction with a content item of a set of content items; and
select the content item for display on the electronic device based on the generated probability for the selected content item.

16. (canceled)

17. The computing device of claim 11, wherein the plurality of instructions, when executed, further cause the computing device to:
receive a third set of data, the third set of data including one or more user engagement metrics;
based on the third set of data using the trained predictive model, determine a likelihood of a targeted content being selected by users; and
upon determination of the likelihood of user selection, present a prediction value of the targeted content.

18. A non-transitory computer-readable medium storing instructions for training a predictive model for suggesting content for users, the instructions when executed by one or more processors of a computing device, cause the computing device to:
receive a first set of data, the first set of data indicative of one or more user engagement metrics;
train a predictive model based on the first set of data using a regularized loss algorithm, the regularized loss algorithm including a loss function with a regularization term, wherein the loss function is a binary cross entropy (BCE) function, and the regularization term is adapted to normalize logits used for the BCE;
receive a second set of data;
generate an output using the predictive model based on the second set of data;
evaluate the output of the predictive model by determining evaluation metrics indicative of predicted performance and reliability of the predictive model;
adjust strength of regularization of the regularized loss algorithm based on the evaluation metrics; and
retrain the predictive model using the regularized loss algorithm, wherein the trained predictive model is used to generate a probability score representing an interaction with a content item and a reliability score representing a confidence level associated with the probability score.

19. The non-transitory computer-readable medium of claim 18, wherein adjusting the strength of regularization of the regularized loss algorithm based on the evaluation metrics comprises adjusting one or more parameters of the regularized loss algorithm to adjust the regularization term based on the evaluation metrics.

20. The non-transitory computer-readable medium of claim 18, wherein the instructions when executed by the one or more processors further cause the computing device to:
receive a third set of data, the third set of data including one or more user engagement metrics;
based on the third set of data using the trained predictive model, determine a likelihood of a targeted content being selected by users; and
upon determination of the likelihood of user selection, present a prediction value of the targeted content.

21. The non-transitory computer-readable medium of claim 18, wherein the computing device is further caused to:
receive a request for content to display to an electronic device;
generate, using the trained predictive model, the probability of an interaction with a content item of a set of content items; and
select the content item for display on the electronic device based on the generated probability for the selected content item.
